(19) United States
(12) Patent Application Publication
(10) Pub. No.: US 2010/0122977 A1
(43) Pub. Date: May 20, 2010

(54) Combined taoster and utensil knife heater

(76) Inventor: Ue-Ming Yang, Chicago, IL (US)

Correspondence Address: UE-MING YANG, 2712 S. UNION AVE., CHICAGO, IL, 60616, US

(21) Appl. No.: 12/291,755

(22) Filed: Nov. 14, 2008

(51) Int. Cl. H05B 3/06

(52) U.S. Cl. 219/520

(57) ABSTRACT

A combined toaster and knife heater unit allows a food product and a knife blade to be inserted into separate heating chambers through separate entries for simultaneously toasting and heating. Upon completion of toasting cycle of food product, heating of knife blade is also completed. The heated knife blade allows user to easily cut through butter/peanut butter, etc., and easily spread butter/peanut butter, etc. over the toasted food product.

### BACKGROUND OF THE INVENTION

Toaster has been a household appliance for toasting bread/bagel, etc. for long time. Very often, user may desire to spread butter/peanut butter, etc. over the toasted bread/bagel after toasting. It has always been a difficult experience for user to do so. This is because butter/peanut butter, which is normally required to be stored in a refrigerator, can be in a hardened state.

Author of present invention becomes aware that there is a simple solution to easy the task of spreading hardened butter/peanut butter over toasted bread/bagel. That is to preheat the spread knife. A spread knife with hot blade can easily and quickly cut through a chunk of butter/peanut butter. At the same time, hot blade can soften butter/peanut butter while spreading it over toasted bread.

The motivating factor of present invention is to utilize toaster as a heat source for heating the spread knife. The object of present invention is to convert a conventional toaster of prior art to a combined toaster and utensil knife heater unit. Such a combined unit offers the following advantages:

(1). It is cost effective. By utilizing the existing heating elements of toaster, there is no need to install additional heating elements for heating knife. The combined unit of present invention is essentially at the same manufacturing cost of conventional toaster.

(2). It reduces operational cost. The knife can be simultaneously heated up during toasting bread. There is essentially no energy cost for heating knife.

(3). It is user friendly. Upon completion of bread toasting cycle, heating of knife is also completed. User can then remove the toasted bread from toaster, while obtain the heated knife from toaster at the same time.

(4). It is commercially marketable. An independent knife heater in lieu of the combined unit of present invention costs consumer not only extra expenses, but also extra effort to operate. On the contrary, the above advantages (1), (2) and (3) offer the combined unit of present invention a cutting edge in competing with conventional toasters in toaster market.

### SUMMARY OF THE INVENTION

One distinctive aspect of present invention is to allow bread and knife to be inserted through separate entries, and heated up in separate heating chambers without affecting operation and performance of toasting bread.

Another distinctive aspect of present invention is to allow bread and knife to be heated up simultaneously by the existing heating elements for toasting bread.

Another distinctive aspect of present invention is that only blade section of knife is heated up. Conduction heat transfer from blade section to handle section of knife is not sufficient to raise handle temperature to a degree uncomfortable for holding knife handle.

According to present invention, two side by side heating chambers are provided for toasting bread. Each heating chamber is provided between a pair of vertical planar heating elements to receive radiation heat and maximum heat capacity from heating elements. A separate heating chamber, which is capable of receiving heat dissipated from heating elements, is provided for heating knife(s). Knife is inserted into the heating chamber through a separate entry that is distant from the entries for inserting breads.

### BRIEF DESCRIPTION OF DRAWINGS

FIG. 1 is a perspective view of a typical toaster of prior art.

FIG. 2 is a perspective view of the first preferred embodiments of the combined toaster and utensil knife heater unit of present invention.

FIG. 3 is a cross sectional view of FIG. 2.

FIG. 4 is a perspective view of the second preferred embodiments of the combined toaster and utensil knife heater unit of present invention.

FIG. 5 is a cross sectional view of FIG. 4.

FIG. 6 is another cross sectional view of FIG. 4.

### DETAILED DESCRIPTION OF DRAWINGS

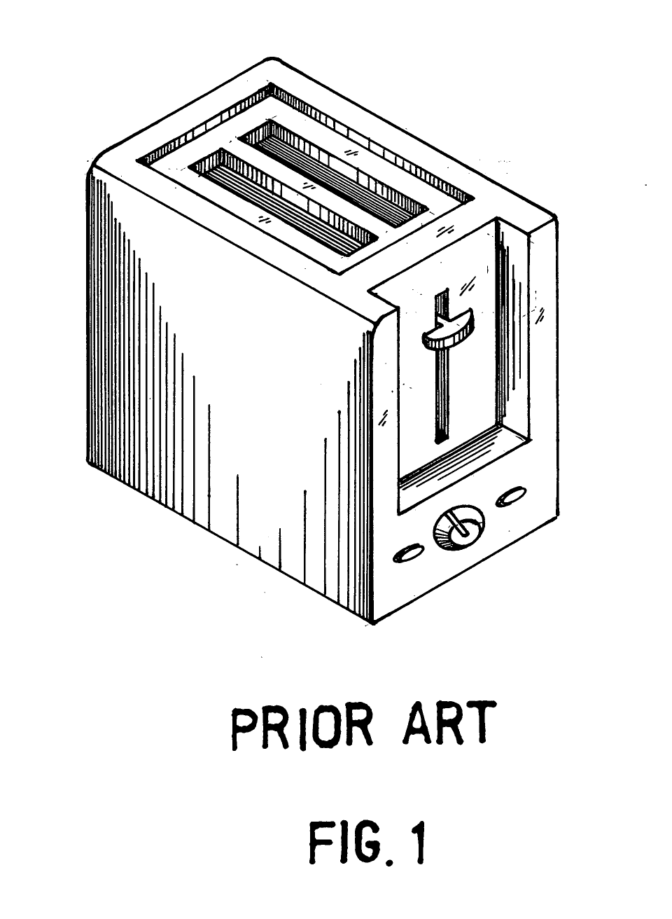

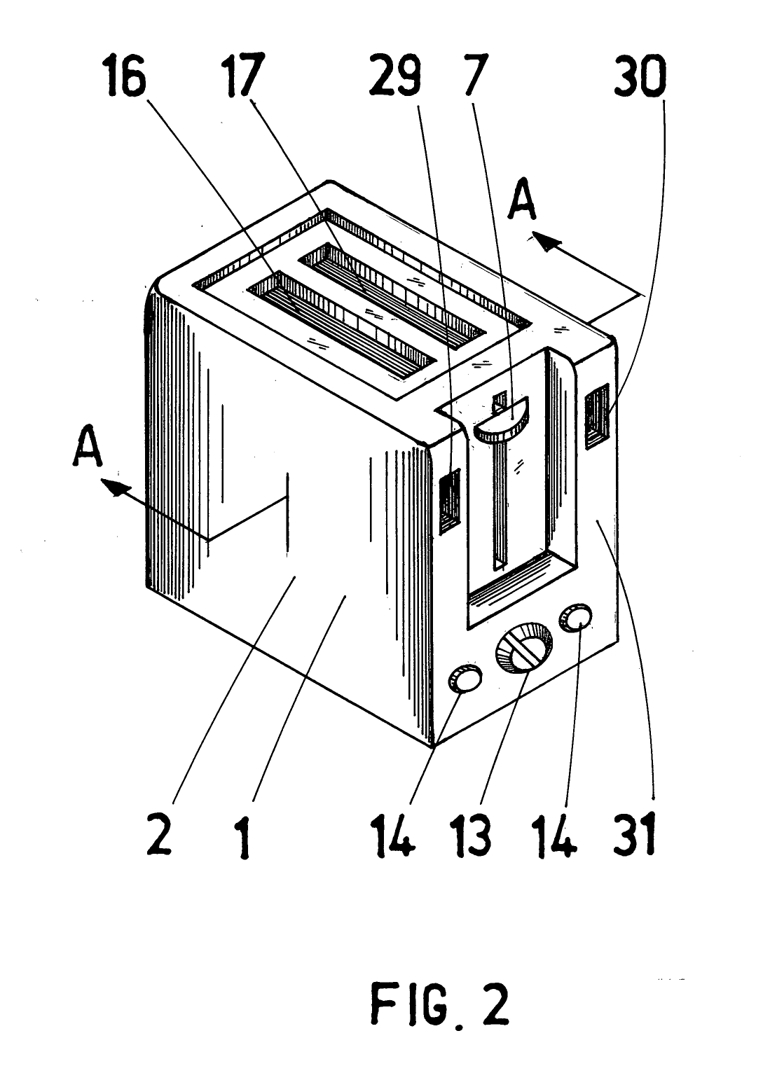

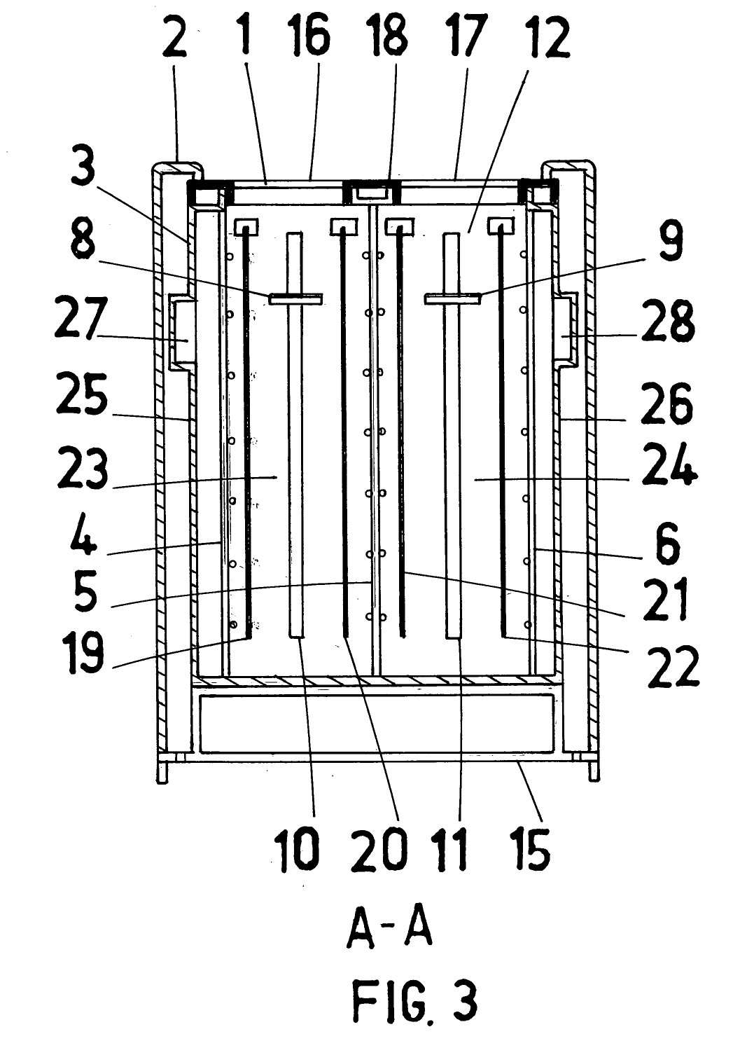

FIG. 1 is a perspective view of a typical toaster of prior art. FIG. 2 is a perspective view of the first preferred embodiments of the combined toaster and utensil knife heater unit of present invention. FIG. 3 is a cross sectional view of FIG. 2.

The object of present invention is to convert a toaster of prior art to a combined toaster and knife heater unit. Many features of the first preferred embodiments of present invention shown in FIG. 2 and FIG. 3 are identical to those of prior art. It is understood that various toasters of prior art may contain various features not shown in FIG. 2 and FIG.3. FIG. 2 and FIG. 3 are not intended to show all various features of prior art, or to limit the features of first preferred embodiments of present invention to only those shown in FIG. 2 and FIG. 3. Other features can be adopted in first preferred embodiments without exceeding the scope of present invention.

Features of the combined unit 1 of first preferred embodiments of present invention shown in FIG. 2 and FIG. 3, which are identical to those of prior art, are described as follows. The combined unit 1 has an outer protective housing 2, an inner metallic housing 3, a left, center and right vertical planar heating elements 4, 5 and 6 spaced within inner housing 3, a control tab 7 for lowering and lifting bread carriages 8 and 9 which are guided by vertical slots 10 and 11 respectively in rear wall 12 of inner housing 3, a control knob 13, control push bottoms 14, a base 15, slot openings 16 and 17 in top wall 18 of inner housing 3 for inserting and removing bread (not shown), and bread support arms 19, 20, 21 and 22. Wherein, inner metallic housing 3 forms a heat shield housing for insulating radiation and convention heat dissipated from heating elements 4, 5 and 6 during operation. Outer protective housing 2 provides a gap between inner housing 3 and outer housing 2 for natural air cooling so that outer housing 2 is maintained at a temperature not harmful for touching by user during operation. Left planar heating element 4 is provided with heat source (i.e., resistance wires) on right side of its reflective plate only. Center planar heating element 5 is provided with heat sources (i.e., resistance wires) on both sides of its reflective plate. Right planar heating element 6 is provided with heat source (i.e., resistance wires) on left side of its reflective plate only. The space between heating elements 4 and 5 forms a left heating chamber 23 for toasting bread. The space between heating elements 5 and 6 forms a right heating chamber 24 for toasting bread. When breads are inserted through slot openings 16 and 17, carriages 8 and 9 retain breads at an upper non-toasting position. Tab 7 is then manually lowered down to lower carriages 8 and 9 to a lower toasting position at where all heating elements 4, 5 and 6 are automatically energized for toasting breads in heating chambers 23 and 24. All heating elements 4, 5 and 6 are automatically shut off at the end of toasting cycle, upon which carriages 8 and 9 are forced to return to the upper non-toasting position by a biased spring (not shown). It is intended to consume the maximum output capacity of heating elements 4, 5 and 6 for toasting breads during toasting cycle.

The novel features of the first preferred embodiments of present invention, which are not provided in toaster of prior art, are described as follows. In FIG. 3, in mid sections of side walls 25 and 26 of inner housing 3, side walls 25 and 26 are projected outwardly to form slot cavities 27 and 28 respectively, which are extended in the longitudinal and horizontal direction within inner housing 3. Slot openings 29 and 30 are provided in front wall 31 of outer housing 2 for inserting a pair of knives (not shown). Behind front wall 31, rectangular channels (not shown) are integrally connected to back side of front wall 31 around slot openings 29 and 30, which are extended in rearward direction with the rear ends closely adjacent to and in alignment with slot cavities 27 and 28 respectively. When knives (not shown) are inserted into slot openings 29 and 30, these channels help to guide the inserted knives to enter into cavities 27 and 28 respectively for heating. These channels are extended long enough so that they restrict lateral movements of the inserted knives, and thus prevent the inserted knives from making contact with heating elements 4 and 6. It is obvious that various means other than the above described channels can be easily adopted to restrict lateral movement of knife, and prevent it from making contact with heating element. Alternatively, these channels and slot cavities 27 and 28 can be in inclined position so that the inserted knife can be retained in inclined position. It becomes apparent that the above first preferred embodiments of present invention has an advantage of being easily retrofit to a toaster of prior art with minimum modifications and at essentially no additional cost.

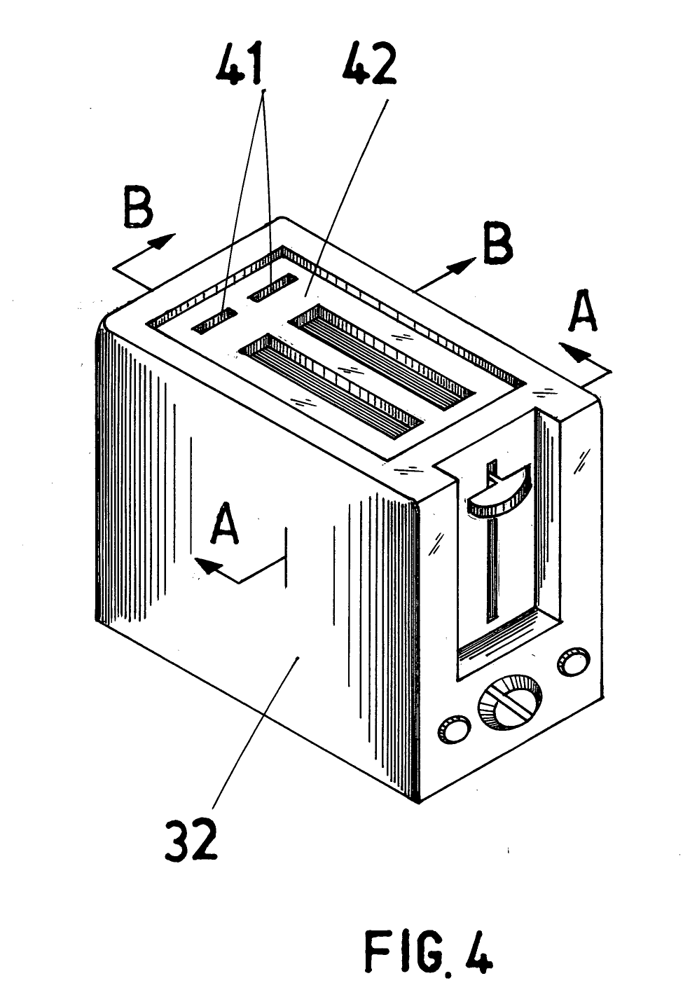

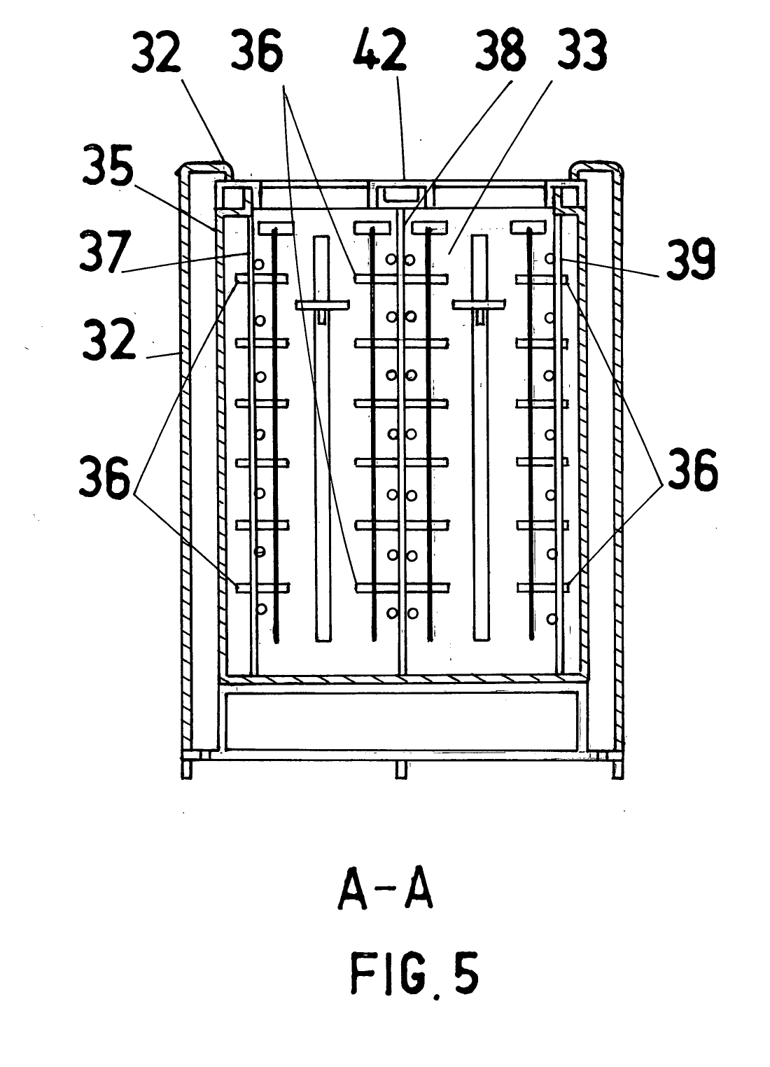

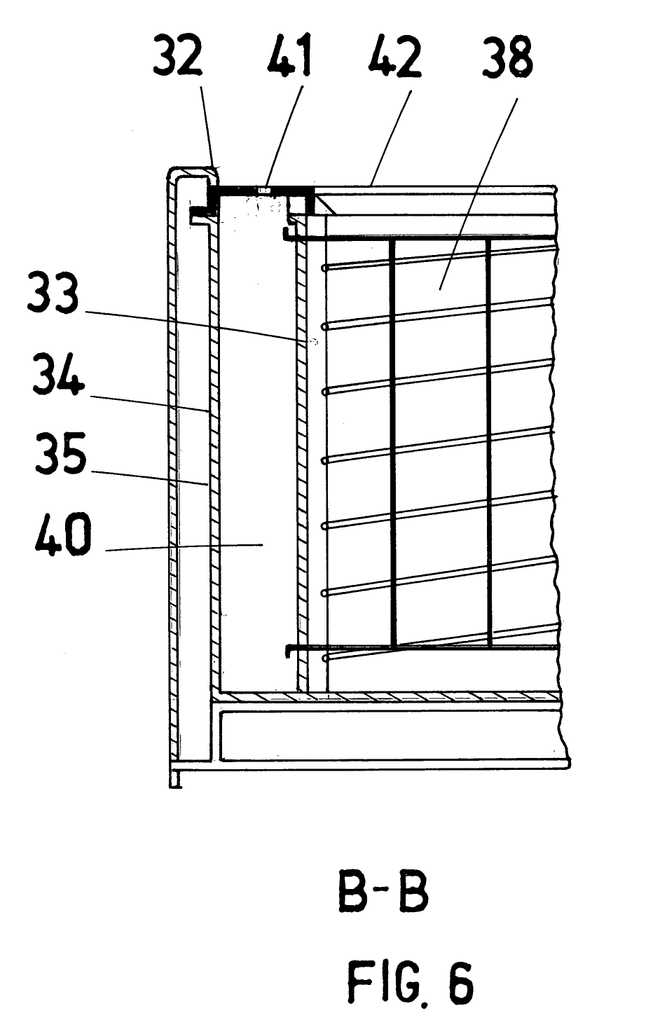

FIG. 4 is a perspective view of second preferred embodiments of the combined toaster and utensil knife heater unit of present invention. FIG. 5 and FIG. 6 are cross sectional views of FIG. 4. Many features of the second preferred embodiments of present invention shown in FIG. 4 through 6 are identical to those of either prior art, or the first preferred embodiments. Again, it is understood that various toasters of prior art may contain various features not shown in FIG. 4 through 6. FIG. 4 through 6 are not intended to show all various features of prior art, or to limit features of the second preferred embodiments of present invention to only those shown in FIG. 4 through 6. Other features can be adopted in second preferred embodiments without exceeding the scope of present invention.

By comparing drawings among FIG. 2 through 6, it becomes apparent that the previously described features of first preferred embodiments, which are identical to those of prior art, are also identical to those of second preferred embodiments. Therefore, these identical features will not be repeatedly described herein.

The novel features of the second preferred embodiments of present invention, which are not provided in toaster of prior art, but are altered from the first preferred embodiments of present invention are described as follows. In FIG. 4 through 6, the combined unit 32 of second preferred embodiments of present invention is provided with a partition wall 33, which is equivalent to rear wall 12 of first preferred embodiments in FIG. 3. Partition wall 33 is located forward to rear wall 34 of inner housing 35. Partition wall 33 is provided with numerous slot openings 36 to facilitate convective heat transfer from heating elements 37, 38 and 39 to the space between rear wall 34 and partition wall 33, which forms a heating chamber 40 within inner housing 35. Slot openings 41 are provided in top wall 42 of inner housing 35 above heating chamber 40. Knife blade (not shown) can be inserted into heating chamber 40 for heating in a relatively vertical position while knife handle (not shown) is stopped and supported by slot opening 41. Partition wall 33 prevents the inserted knife from making contact with heating element 37,38 or 39.

It is understood that the above described preferred embodiments of present invention are for demonstrating rather than limiting the scope of present invention. Modifications and variations are allowed within scope of present invention. For example, multiple entries and multiple heating chambers for inserting and toasting breads, or multiple entries and multiple heating chambers for inserting and heating knives can be adopted without exceeding the scope of present invention. For another example, various control functions and means for toasting operation can also be adopted without exceeding the scope of present invention. For another example, additional heat sources (i.e. resistance wires) can be adopted to right and left sides of left and right heating elements 4 and 6 respectively in first preferred embodiments for heating knives by direct radiation without exceeding the scope of present invention. For another example, if desired, the combined unit of present invention can be operated for toasting bread/bagel, etc and for heating knife individually rather than simultaneously without exceeding the scope of present invention.

What is claimed is:

1). A combined toaster and utensil knife heater unit comprising of:
a first inner metallic housing,
a second outer protective housing enveloping said first housing,
a plural number of vertical planar heating elements being provided within said first housing, at least
a first heating chamber being provided within said first housing for toasting a food product, at least
a second heating chamber apart from said first heating chamber being provided within said first housing for heating said knife, at least
a first entry being provided through walls of said first and second housings for inserting said food product into said first heating chamber for toasting, and for removing said food product from said first heating chamber after toasting, at least
a second entry apart from said first entry being provided through walls of said first and second housings for inserting said knife into said second heating chamber for heating, and for removing said knife from said second heating chamber after heating,
wherein:
said first housing forming a heat shield housing for insulating radiation and convention heat dissipated from said heating elements during operation; and
said second housing providing a gap between said first and second housings for natural air cooling so that said second housing is maintained at a temperature not harmful for touching by user during operation; and
said food product and said knife capable of being heated up simultaneously in said first and second heating chambers respectively.

2). The combined toaster and utensil knife heater unit according to claim 1, in which, a first moveable carriage is provided within said first heating chamber for receiving and retaining said inserted food product at a first upper non-toasting position, and a second fixed carriage is provided within said second heating chamber for receiving and retaining said inserted knife at a fixed position, wherein:
said first carriage is capable of being manually lowered down from said first upper non-toasting position to a second lower toasting position, in which said heating elements are automatically energized for toasting said food product and heating said knife; and
said heating elements are capable of being automatically shut off at an end of toasting cycle; and
said first carriage is capable of being automatically returned from said second lower toasting position to said first upper non-toasting position at said end of toasting cycle.

3). The combined toaster and utensil knife heater unit according to claims 1 and 2, in which, said first heating chamber is provided in a space between a pair of said vertical planar heating elements.

4). The combined toaster and utensil knife heater unit according to claims 1 and 2, in which, said second heating chamber is provided in a space between one of side walls of said first housing and one of said vertical planar heating elements, said second fixed carriage is formed of an outwardly projected slot in said side wall which supports and retains said knife in a relatively horizontal position within said second heating chamber, and said second entry is in alignment with a front opening of said second fixed carriage, and passing through a first and second front walls of said first and second housings respectively.

5). The combined toaster and utensil knife heater unit according to claims 1 and 2, in which, said second heating chamber is provide in a space between one of side walls of said first housing and one of said vertical planar heating elements, said second fixed carriage is formed of an outwardly projected slot in said side wall which supports and retains said knife in inclined position within said second heating chamber, and said second entry is in alignment with a front opening of said second fixed carriage, and passing through a first and second front walls of said first and second housings respectively.

6). The combined toaster and utensil knife heater unit according to claims 1 and 2, in which, said first inner housing is divided into a front section and a rear section by a lateral partition wall, said heating elements and said first heating chamber are provided in said front section, said rear section forms said second heating chamber, said lateral partition wall has numerous openings to facilitate heat transfer from said front section to said rear section, said second fixed carriage and said second entry are formed of a slot opening in a top wall of said first inner housing above said rear section, which supports and retains said knife in a relatively vertical position within said second heating chamber.

7). The combined toaster and utensil knife heater unit according to claims 4 and 5, in which, a means is provided for restricting lateral movement of said knife and preventing said knife from making contact with said heating elements.

8). The combined toaster and utensil knife heater unit according to claims 4, 5 and 7, in which, said means for restricting lateral movement of said knife and preventing said knife from making contact with said heating elements is provided by an extended channel, which envelopes and guides said knife between said second entry and said front opening of said second fixed carriage.

9). The combined toaster and utensil knife heater unit according to claim 1, in which, it is operated with only said food product being inserted into said first heating chamber.

10). The combined toaster and utensil knife heater unit according to claim 1, in which, it is operated with only said knife being inserted into said second heating chamber.
